(19) United States
(12) Patent Application Publication
(10) Pub. No.: US 2025/0044914 A1
(43) Pub. Date: Feb. 6, 2025

(54) METHOD, SERVER AND USER TERMINAL FOR PROVIDING EMOTICON INPUT INTERFACE

(71) Applicant: KAKAO CORP., Jeju-si (KR)

(72) Inventors: Hyeon Seon CHO, Seongnam-si (KR); Da Eun YUN, Seongnam-si (KR); Nam Hee KO, Seongnam-si (KR); Jin Sil PARK, Seongnam-si (KR); Ra Sun KIM, Seongnam-si (KR); Jeong Min YOON, Seongnam-si (KR); Eu Gene SHIN, Seongnam-si (KR); Da Rim KIM, Seongnam-si (KR); Heung Soo KIM, Seongnam-si (KR); Hyo Joo KIM, Seongnam-si (KR); Ji Yeong KIM, Seongnam-si (KR); Seung Mok OH, Seongnam-si (KR); I Jin YUN, Seongnam-si (KR); Ho Jun KIM, Seongnam-si (KR); Do Yeon KIM, Seongnam-si (KR); Jeong Ryeol CHOI, Seongnam-si (KR)

(21) Appl. No.: 18/609,575

(22) Filed: Mar. 19, 2024

(30) Foreign Application Priority Data
Aug. 3, 2023 (KR) 10-2023-0101851

(51) Int. Cl. G06F 3/0482; G06F 3/0483

(52) U.S. Cl. CPC G06F 3/0482; G06F 3/0483

(57) ABSTRACT

Proposed is a method for providing an emoticon input interface by a user terminal. The method may include displaying a first input interface for inputting an emoticon to be posted on a profile page of a user. The method may also include receiving a selection interaction of selecting a first emoticon to be posted on the profile page of the user via the first input interface, and displaying the selected first emoticon on the profile page of the user. The first input interface may include user custom information associated with emoticon historical information of the user. The user custom information may be identical to at least a part of user custom information for a second input interface for inputting an emoticon to be displayed in a chat message.

### CROSS-REFERENCE TO RELATED APPLICATION

This application claims priority to and the benefit of Korean Patent Application No. 10-2023-0101851 filed on Aug. 3, 2023, the disclosure of which is incorporated herein by reference in its entirety.

### BACKGROUND

### Technical Field

The present disclosure relates to a method for providing an emoticon input interface for inputting emoticons into chat message and profile pages in a messenger application that provides a chat function.

### Description of Related Technology

With recent advancements in mobile technology and improvements in smart device performance, instant messaging services, enabling users to send and receive messages, have become ubiquitous.

### SUMMARY

The present disclosure provides an emoticon input interface for conveniently posting an emoticon to a user's profile page on a messenger service.

Regarding an emoticon input interface provided for posting an emoji to a user's profile page of a messenger service, the present disclosure provides to provide an emoticon input interface that reflects the user's emoticon historical information.

In one general aspect, there is provided a method for providing an emoticon input interface by a user terminal, the method including: displaying a first input interface for inputting an emoticon to be posted on a profile page of a user; receiving a selection interaction of selecting a first emoticon to be posted on the profile page of the user via the first input interface; and displaying the selected first emoticon on the profile page of the user. The first input interface includes user custom information associated with emoticon historical information of the user. The user custom information is identical to at least a part of user custom information for a second input interface for inputting an emoticon to be displayed in a chat message.

The historical information may be associated with at least one of the user's recent usage history, favorite history, purchase history, download history, and possession history regarding emoticons.

Each of the first and second input interfaces may include: a tab area having at least one tab associated with the historical information; and a selection area for displaying an emoticon thumbnail to be selected by a selection interaction. The user custom information may be displayed in the tab area.

In both the first and second input interfaces, tabs in the tab area may be provided with same configuration and order.

The profile page of the user may include a profile background and a profile image. The first emoticon may be displayed and posted on at least one of the profile background and the profile image.

The method may further include: when the first emoticon is displayed and included in the profile background, displaying an editing interface for inputting information about a format in which the first emoticon is displayed in the profile background, wherein displaying the editing interface is performed between receiving the selection interaction and displaying the profile page.

When the first emoticon is displayed and included in the profile background, the first emoticon may be displayed in association with the profile image.

The method may further include: receiving text information to be posted along with the first emoticon on the profile page of the user. In displaying the first emoticon, the text information input to the profile page of the user may be displayed along with the first emoticon. When receiving the text information is performed before receiving the selection interaction, the first input interface may include information about at least one recommended emoticon associated with the text information in displaying the first input interface.

The method may further include receiving text information to be posted along with the first emoticon on the profile page of the user. In displaying the first emoticon, the text information input to the profile page of the user may be displayed along with the first emoticon. When receiving the selection interaction is performed before receiving the text information, the text input interface for inputting the text information may include at least one recommended text information associated with the first emoticon in receiving the text information.

In displaying the profile page, the first emoticon may be displayed in a modified manner different from a manner in which the first emoticon is displayed in the chat message.

The manner in which the first emoticon is displayed in the chat message comprises an animated image, the modified manner may be at least one of the following: a manner in which the animated image is played repeatedly and a manner in which a still image associated with a still image is displayed.

The method may further include, after displaying the first emoticon, displaying an editing interface to change information about a format in which the first emoticon is displayed on the profile page. In displaying the editing interface, when the user's right to use the first emoticon expires, an editing interface with restricted functionalities may be displayed, compared to when the right to use the emoticon is valid.

Displaying the first emoticon may include providing an interface that connects to an emoticon set comprising the first emoticon.

The method may further include: displaying a second emoticon posted on a profile page of a different user; displaying a third input interface for inputting an emoticon to be posted on the profile page of the different user; receiving a selection interaction of selecting a third emoticon to be posted on the profile page of the different user via the third input interface; and displaying the selected third emoticon on the profile page of the different user along with the second emoticon. The third input interface may be identical to at least a part of custom information for the first input interface.

In displaying the third input interface, the third input interface may include information about at least one recommended emoticon associated with the second emoticon.

The method may further include, after displaying the first emoticon, displaying, along with the first emoticon, a fourth emoticon posted on the profile page of the user, wherein the fourth emoticon is an emoticon requested by the different user to be posted on the user's profile page in association with the first emoticon.

In another aspect, there is provided a user terminal for providing an emoticon input interface, the user terminal including a memory storing instructions and a processor connected to the memory and configured to execute the instructions to: display a first input interface for inputting an emoticon to be posted on a profile page of a user; receive a selection interaction of selecting a first emoticon to be posted on the profile page of the user via the first input interface; and display the selected first emoticon on the profile page of the user. The first input interface may include user custom information associated with emoticon historical information of the user. The user custom information may be identical to at least a part of user custom information for a second input interface for inputting an emoticon to be displayed in a chat message.

In yet another aspect, there is provided a method for providing an emoticon input interface by a server, the method including: receiving a request from a user terminal to post an emoticon on a profile page of a user; providing the user terminal with a first input interface for inputting an emoticon to be posted on the profile page of the user; receiving selection information regarding selection of a first emoticon to be posted on the profile page of the user from the user terminal via the first input interface; and providing the user terminal with the selected first emoticon on the user's profile page. The first input interface includes user custom information associated with emoticon historical information of the user. The user custom information is identical to at least a part of user custom information for a second input interface for inputting an emoticon to be displayed in a chat message.

The method may further include, after providing the first emoticon, providing an editing interface to change information about a format in which the first emoticon is to be displayed on the profile page. In providing the editing interface, when the user's right to use the first emoticon expires, an editing interface with restricted functionality may be provided compared to when the right to use the first emoticon is valid.

In yet another aspect, there is provided a method for providing an emoticon input interface by a server, the method including: receiving a request from a user terminal to post an emoticon on a profile page of a user; providing the user terminal with a first input interface for inputting an emoticon to be posted on the profile page of the user; receiving selection information regarding selection of a first emoticon to be posted on the profile page of the user from the user terminal via the first input interface; and providing the user terminal with the selected first emoticon on the profile page of the user. The first input interface includes user custom information associated with emoticon historical information of the user. The historical information is associated with at least one of the user's recent usage history, favorite history, purchase history, download history, and possession history regarding emoticons.

In yet another aspect, there is provided a server for providing an emoticon input interface, the server including a memory storing instructions and a processor connected to the memory and configured to execute the instructions to: receive a request from a user terminal to post an emoticon on a profile page of a user; provide the user terminal with a first input interface for inputting an emoticon to be posted on the profile page of the user; receive selection information regarding selection of a first emoticon to be posted on the profile page of the user from the user terminal via the first input interface; and provide the user terminal with the selected first emoticon on the user's profile page. The first input interface includes user custom information associated with emoticon historical information of the user. The user custom information is identical to at least a part of user custom information for a second input interface for inputting an emoticon to be displayed in a chat message.

### BRIEF DESCRIPTION OF THE DRAWINGS

FIG. 1 is a diagram illustrating an example of a network environment according to an embodiment of the present disclosure.

FIG. 2 is a flowchart for explaining how a user terminal of the present disclosure provides an emoticon input interface.

FIGS. 3 to 8 show screens in the process of performing a method for providing an emoticon input interface by one user terminal or the other user terminal according to embodiments of the present disclosure.

FIG. 9 shows a table for explaining the types of emoticons displayed in a profile background or profile image of a profile page on a user terminal.

FIG. 10 is a flowchart for explaining a method for providing an emoticon input interface by a user terminal of the present disclosure.

FIG. 11 illustrates an example screen in the process of performing a method for providing an emoticon input interface by a user terminal according to embodiments of the present disclosure.

FIG. 12 is a flowchart for explaining a method for providing an emoticon input interface by a user terminal of the present disclosure.

FIG. 13 illustrates an example screen in the process of performing a method for providing an emoticon input interface by a user terminal according to embodiments of the present disclosure.

FIG. 14 is a flowchart for explaining a method for providing an emoticon input interface by a user terminal of the present disclosure.

FIG. 15 illustrates an example screen in the process of performing a method for providing an emoticon input interface by a user terminal according to embodiments of the present disclosure.

FIG. 16 is a flowchart for explaining a method for providing an emoticon input interface by a user terminal of the present disclosure.

FIG. 17 illustrates an example screen in the process of performing a method for providing an emoticon input interface by a user terminal according to embodiments of the present disclosure.

FIG. 18 is a flowchart for explaining a method for providing an emoticon input interface by a server of the present disclosure.

### DETAILED DESCRIPTION

Recent messenger services provide users with the ability to display various information on their profile pages. Consequently, users often personalize their profile pages according to their preferences. These profile pages serve as a common platform for users to express their personalities on messaging platforms.

Moreover, recent messenger services support sending and receiving messages that include images, videos, audio, or emoticons (emojis) in addition to text. In particular, users of many messaging services are using emoticons in their instant messages to effectively express their emotions.

When displaying various information on a user's profile page, emoticons are increasingly used to effectively express emotions. As emoticon usage on profile pages continues to rise, there is an increasing demand for a more effective and user-friendly method of inputting an emoticon.

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

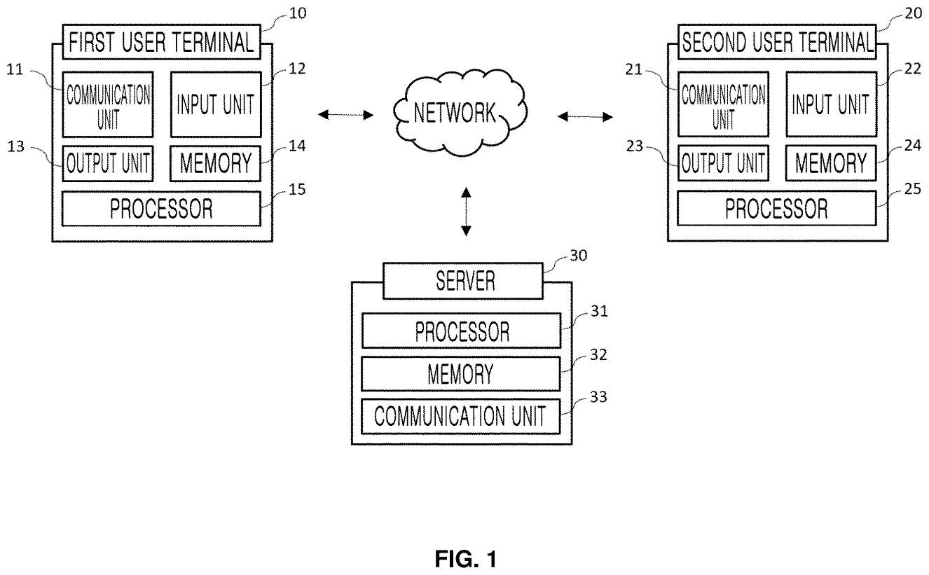

FIG. 1 is a diagram illustrating an example of a network environment according to an embodiment of the present disclosure.

A network environment according to an embodiment of the present disclosure shown in FIG. 1 may include user terminals 10 and 20 and a server 30. The user terminals 10 and 20 may correspond to at least one user terminal 10 connected to the server 30 over a network. FIG. 1 illustrates a first user terminal 10 and a second user terminal 20 as exemplary user terminals.

The first user terminal 10 refers to a terminal that a first user logs into with the first user's account registered on the server 30, and the second user terminal 20 refers to a terminal that a second user logs into with the second user's account registered on the server 30.

The user terminals 10 and 20 may be terminals that users logs into with the users' accounts registered with a messenger service, social media service, or social network service (SNS) provided by the server 30. For example, the user terminals 10 and 20 each may correspond to a PC or a smartphone. If the user terminal 10 or 20 is a PC, the user terminal may be operated by an operating system such as Windows, macOS, or Linux.

Communication schemes for a network is not limited. The communication schemes may include not only a communication scheme to utilize a telecommunication network (for example, a mobile communication network, wired Internet, wireless Internet, and a broadcast network), but also a short-range radio communication scheme.

The user terminals 10 and 20 may include communication units 11 and 21, input units 12 and 22, output units 13 and 23, memories 14 and 24, and processors 15 and 25.

The communication units 11 and 21 may communicate with the server 30 or other terminals in a wired or wireless manner.

The input units 12 and 22 may receive various information through a user's operation and input action. Such input units 12 and 22 may be a touch screen module, keyboard, mouse, button, camera, stylus, microphone, etc.

The user terminals 10 and 20 may receive a user's interaction through the input units 12 and 22. An interaction indicates the user operating an input unit to enter information reflecting the user's selection or intention into the user terminal 10. For example, the interaction may include touching on a touchscreen, clicking with a mouse, typing on a keyboard, providing voice input through a microphone, capturing an image using a camera, recognizing movements through a motion sensor, and the like.

The output units 13 and 23 may output various information. The output units 13 and 23 may be a display device, a speaker, a vibration generator, a tactile generator, etc. In some cases, the output units 13 and 23 may be a device (e.g., Bluetooth earphone) that is connected to the user terminals 10 and 20 through wired or wireless communication (e.g., short-range radio communication such as Bluetooth) to receive and output a signal.

The memories 14 and 24 function as a storage medium and may store a plurality of application programs serve as running on the user terminal 10 and 20 and data and instructions for operating the user terminal 10 and 20. These memories 14 and 24 may be provided in the form of any of various hardware storage devices such as an ROM, an RAM, a flash drive, a hard drive, etc. or may be provided in the form of web storage.

In one embodiment, the memories 14 and 24 may store the application associated with the messenger service, social media service, or social network service (SNS).

The processor 15 and 25 may execute the application associated with the messenger service, social media service, or social network service (SNS) by controlling the overall operation of the communication units 11 and 21, the input units 12 and 22, the output units 13 and 23, and the memories 14 and 24.

Hereinafter, for the sake of convenience in explanation, a user terminal 10 refers to the first user terminal 10, and the other user terminal 20 refers to the second user terminal 20.

The user terminal 10 may execute an application associated with a messenger service, social media service, or social network service (SNS) to provide a user with the function to enter information into the user's profile page, the function to display the user's or the other user's profile page, and the function to send and receive chat messages via a chat room. The present disclosure relates to the user terminal 10 providing an emoticon input interface.

The user terminal 10 may display a first input interface for inputting an emoticon to be posted on the user's profile page, receive a selection interaction of selecting a first emoticon to be posted on the user's profile page via the first input interface, and then display the selected first emoticon on the user's profile page.

The first input interface may include user customization information associated with the user's emoticon historical information, and the user customization information may be identical to at least a part of user customization information for a second input interface for inputting an emoticon to be displayed in the chat message.

Here, the profile page refers to a page or interface that displays the user's personal information, status information, or preference information in the messenger service, social media service, or social network service (SNS) provided by the server 30. The profile page may include the user's name, profile image (photo), status message, contact information, profile background photo, etc.

The profile pages may be provided corresponding to each user of the service provided by the server 30. Therefore, in the present disclosure, a user's profile page may refer to the first user's profile page, and the other user's profile page may refer to the second user's profile page.

Here, an emoticon refers to graphical information that expresses a user's emotions or facial expressions. The emoticon may consist of various types of graphical or multimedia information. For example, the emoticon may include a still image, an animated image, or sound information. An emoticon should be selected to match the emotion or facial expression a user wishes to express, but is not easily searched for and selected using conventional text input methods. For this reason, an emoticon input interface may be provided to facilitate searching for and selecting an emoticon.

Here, the first and second input interfaces refer to interfaces for a user to select an emoticon and input information regarding the selection of the emoticon into the user terminal 10. In the present disclosure, the first input interface corresponds to an input interface for inputting an emoticon to be posted on the user's profile page, and the second input interface corresponds to an input interface for inputting an emoticon to be displayed in a chat message in a chat room.

Here, the user custom information refers to information provided in association with the user's emoticon historical information when providing an emoticon input interface to the user.

Here, the user's emoticon historical information refers to information that the user has previously used, purchased, downloaded, or possessed emoticons on the service provided by the server 30. For example, the user's emoticon historical information may be associated with at least one of the user's recent usage history, favorite history, purchase history, download history, and possession history regarding emoticons.

The other user terminal 20 may view the user's profile page. Accordingly, the other user terminal 20 may display the user's profile page where an emoticon is posted. The other user terminal 20 may input a reaction emoticon to the emoticon posted on the user's profile page. This reaction emoticon may be posted on the user's profile page and thus displayed on the user terminal 10 and the other user terminal 20.

The server 30 may be implemented as a computer device or a plurality of computer devices that provide commands, codes, files, content, services, etc. The server 30 may be a server 30 capable of transmitting and receiving information through communication with the user terminals 10 and 20 over a network.

The server 30 may include a processor 31, a memory 32, and a communication unit 33.

The processor 31 may control the overall operation of the memory 12 and the communication unit 13 to provide a messenger service, social media service, or social network service (SNS) to the user terminals 10 and 20.

The memory 32 functions as a storage medium and may store a number of application programs running on the server 30, and data and commands for operation of the server 30. In one embodiment, the memory 32 may store an application program that provides a messenger service, social media service, or social network service (SNS).

This memory 32 may be provided in the form of any of various hardware storage devices such as an ROM, an RAM, a flash drive, a hard drive, etc. or may be provided in the form of web storage.

The communication unit 33 may communicate with the user terminal 10 in a wired or wireless manner over a network.

The server 30 of the present disclosure may provide a messenger service, social media service, or social network service (SNS) to the user terminals 10 and 20. The server 30 may provide the user terminals 10 and 20 with the function to input and post information to the user's profile page and the function to send and receive chat messages via a chat room. The present disclosure relates to the server 30 providing an emoticon input interface to the user terminals 10 and 20.

The server 30 may receive a request from the user terminal 10 to post an emoticon to the user's profile page, provide the user terminal 10 with a first input interface for inputting an emoticon to be posted to the user's profile page, receive, from the user terminal 10, selection information regarding selection of a first emoticon to be posted to the user's profile page via the first input interface, and provide the user terminal 10 with the selected first emoticon on the user's profile page.

Here, the first input interface may include user customization information associated with the user's emoticon historical information, and the user customization information may be identical to at least a part of user customization information for the second input interface for inputting an emoticon to be displayed in a chat message.

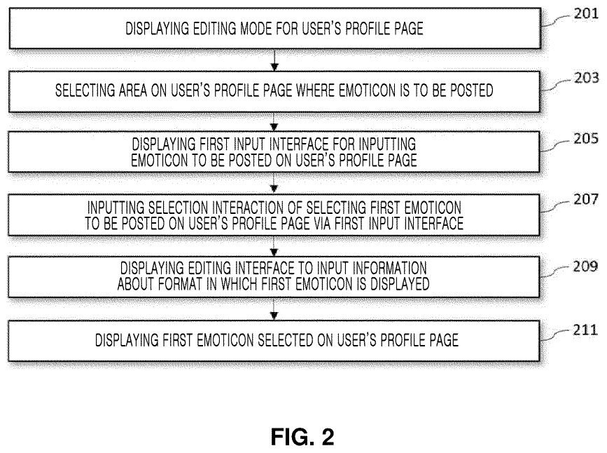

Hereinafter, an embodiment of a method for providing an emoticon input interface by a user terminal 10 of the present disclosure will be described with reference to FIGS. 2 to 9.

FIG. 2 is a flowchart for explaining how the user terminal 10 of the present disclosure provides an emoticon input interface.

In operation 201, the user terminal 10 displays an editing mode for a user's profile page.

The user terminal 10 may provide the editing mode for the user to add or change content to the user's profile page. In response to the user's request to edit the user's profile page, the user terminal 10 may display the editing mode that includes an editing interface for the user's profile page.

In operation 203, the user terminal 10 selects an area on the user's profile page where an emoticon is to be posted.

In the editing interface for the user's profile page, the user terminal 10 may provide the function to post an emoticon to at least one of a profile background and a profile image. In the editing interface for the user's profile page, the user may select one of the profile background and profile image to post an emoticon.

In operation 205, the user terminal 10 displays a first input interface for inputting an emoticon to be posted on the user's profile page.

The first input interface is an interface for inputting an emoticon to be posted on the profile page. Via the first input interface, the user may search or view a plurality of emoticons and select an emoticon desired to post based on a plurality of emoticon thumbnails displayed in a sorted manner.

The first input interface may include a tab area and a selection area. Within the tab area, a plurality of tabs may be displayed. When one of the plurality of tabs is selected, thumbnails of one or more emoticons corresponding to the selected tab may be displayed in the selection area. The user may select a desired emoticon by selecting one of the thumbnails displayed in the selection area.

The multiple tabs in the tab area may be divided into various types. Specifically, the tab may be at least one of a Favorites tab, a Recently Used tab, an Announcements tab, a Recently Popular tab, a Recommendation tab, and a Custom Set tab.

Here, the Custom Set tab may be a tab corresponding to an emoticon set designated by the user through purchasing, downloading, possessing, receiving as a gift, or the like. Here, an emoticon set refers to a group of emoticons organized by topic, keyword, character, content, etc. The server 30 may provide functions such as purchasing, downloading, possessing, and gifting an emoticon set containing a plurality of emoticons as a unit rather than individual emoticons. Therefore, the Custom Set tab described above may also be provided corresponding to the emoticon set. The Custom Set tab may be displayed as an icon image of the emoticon set in the tab area.

The first input interface may be customized and provided based on the user's information. To this end, the first input interface may include user customization information that is customized based on the user's information. The user custom information may be associated with the user's emoticon historical information.

The user's emoticon historical information may be information about actions the user has previously performed regarding emoticons while using the service which is provided by the server 30 to the user. Specifically, the user's emoticon historical information may be associated with at least one of the user's recent usage history, favorite history, purchase history, download history, and possession history regarding emoticons.

Here, the recent usage history may be information about emoticons used by the user while utilizing the service of the server 30 over a predetermined period of time (e.g., 30 days), or information about emoticons most recently used by the user within a predetermined number (e.g., 12). In addition, the purchase history may be information indicating that the user has acquired emoticons, either through paid or free transactions, while using the service of the server 30. In addition, the download history may be information indicating that the user has downloaded information on emoticons (e.g., image information) from the server 30. In addition, the possession history may be information indicating that the user has possessed emoticons through purchasing, downloading, or receiving a gift while using the service of the server 30.

While providing the service to the user, the first user terminal 10 or the server 30 may store actions performed by the user on emoticon as historical information. Therefore, the first user terminal may provide a first input interface based on the user's stored history regarding emoticons. In some cases, the historical information may be stored corresponding to the user's account. Therefore, the first user terminal 10 or the server 30 may provide the first input interface based on the user's emoticon historical information, even if the user utilizes the service of the server 30 with the same account using a different terminal.

In the first input interface, the user custom information may be reflected as information in which tabs are displayed in the tab area. Specifically, the tabs in the tab area may be displayed as graphic images customized based on the user's information. For example, if the Recently Used tab is displayed in the tab area, the Recently Used tab in the tab area may be displayed as an icon based on the thumbnail icon of one of the emoticons most recently used by the user, rather than a generic icon image that implies recent use. In this case, the Recently Used tab in the tab area may be displayed differently for each user of the service of the server 30.

In addition, the order in which tabs are arranged in the tab area may also reflect the user's emoticon historical information. For example, if there is a plurality of Custom Set tabs, the order in which the plurality of Custom Set tabs is displayed may be based on the order specified by the user separately or the order in which the user has purchased, downloaded, or possessed corresponding emoticon sets.

In some cases, a default tab to be selected when the first input interface is first displayed may also reflect the user's historical information. For example, a tab that the user last selected in the existing input interface may be selected and displayed by default when the first input interface is first displayed.

As described above, because the first input interface reflects the user custom information, the first input interface may be displayed differently for each user. Therefore, there is an advantage of inputting an emoticon more conveniently because a user is able to input the emoticon through an emoticon input interface that reflects the user's history or preferences.

The first input interface provided for inputting an emoticon to be posted on the user's profile page may be identical or similar to another emoticon input interface provided in the service of the server 30. In particular, the first input interface may share at least a part of user customization information with another emoticon input interface.

For example, the first input interface may be identical or similar to a second input interface for inputting an emoticon to be displayed in a chat message within the chat service provided by the server 30. Specifically, the user custom information for the first input interface may be identical to at least a part of user custom information for the second input interface.

There is an advantage in that the user uses emoticon input interfaces having the same information, so that the user can conveniently input emoticons in association with various functions provided by the server 30. If the user custom information for one of the first and second input interfaces is changed, this change may be simultaneously or immediately reflected in the other input interface.

In operation 207, the user terminal 10 receives a selection interaction of selecting a first emoticon to be posted on the user's profile page via the first input interface.

When one tab is selected in the tab area of the first input interface, an emoticon thumbnail corresponding to the tab is displayed in the selection area. The user may select a desired emoticon by inputting a selection interaction of selecting the emoticon thumbnail displayed in the selection area.

In operation 209, the user terminal 10 displays an editing interface for inputting information about a display format of the emoticon.

The user terminal 10 may provide an editing function for modifying or changing the format in which the first emoticon is to be displayed on the profile page. To this end, the user terminal 10 may display an editing interface regarding the first emoticon. The user terminal 10 may input information about the size, position, and rotation of the emoticon displayed on the profile page through the editing interface.

In operation 211, the user terminal 10 displays the selected first emoticon on the user's profile page.

When the user also determines the form of the first emoticon to be displayed on the profile page, the server 30 may post the first emoticon on the user's profile page. The server 30 may provide the user's profile page on which the first emoticon is posted not only to the user terminal 10 but also to the other user terminal 20.

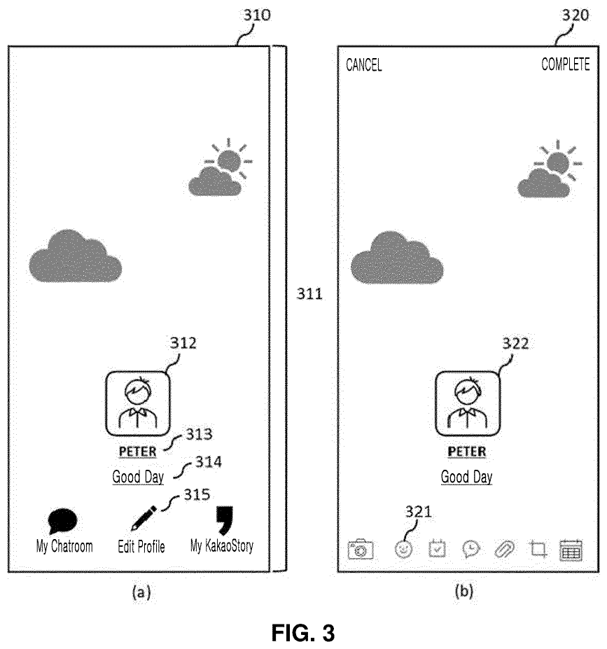

Hereinafter, an example of a method in which the user terminal 10 described with reference to FIG. 2 provides an emoticon input interface will be described with reference to FIGS. 3 to 9.

FIGS. 3 to 8 exemplarily show screens in the process of performing a method for providing an emoticon input interface by the user terminal 10 or the other user terminal 20 according to embodiments of the present disclosure.

FIG. 3 illustrates a screen of the user terminal 10 having performed operation 201 of FIG. 2.

Referring to (a) of FIG. 3, the user terminal 10 may display a user's profile page 310. The user's profile page 310 may include a profile background 311, a profile image 312, a user name 313, and a status message 314. In addition, the user's profile page may display an interface 315 associated with a function for modifying or editing the user's profile page.

Referring to (b) of FIG. 3, the user terminal 10 may display an editing interface 320 for editing a profile page in response to an interaction with the interface 315.

The editing interface 320 may include a menu interface 321 and a profile image interface 322 for inputting an emoticon in the profile background. The user may input an interaction with one of the editing interfaces to select an area on the user's profile page where an emoticon is to be posted (see operation 203 in FIG. 2).

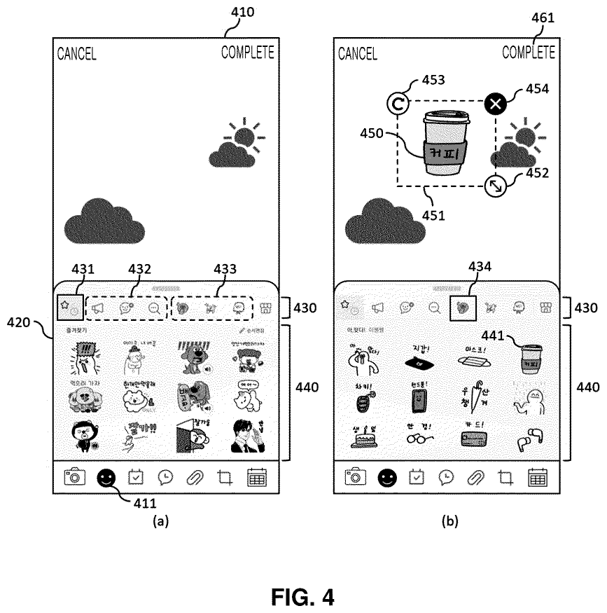

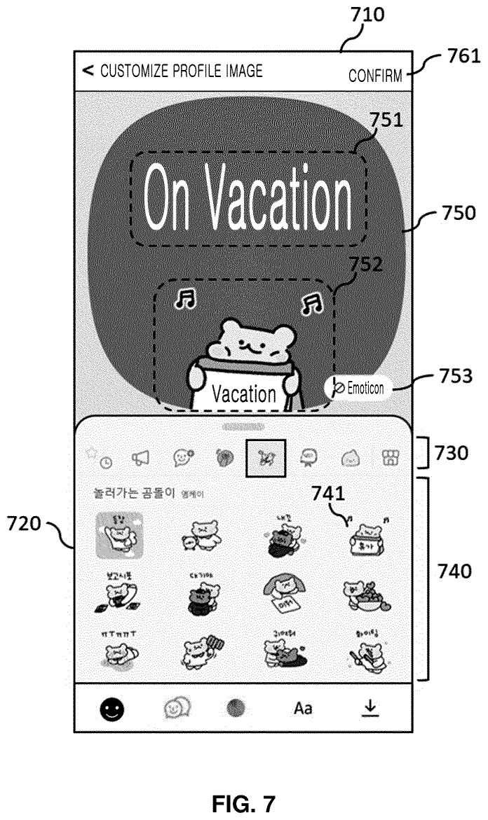

When the user inputs an interaction with the menu interface 321, the user terminal 10 may display a screen (see FIG. 4) for posting an emoticon in the background of the profile page. In addition, when the user inputs an interaction with the profile image interface 322, the user terminal 10 may display a screen (see FIG. 7) for posting an emoticon in the profile image.

FIG. 4 illustrates a screen of the user terminal 10 having performed operations 205, 207, and 209 of FIG. 2. Specifically, FIG. 4 corresponds to a screen for posting an emoticon on the background of the profile page.

In (a) of FIG. 4, there is illustrated a screen of the user terminal 10 having performed operation 205 of FIG. 2.

Referring to (a) of FIG. 4, the user terminal 10 may display a first input interface 420. The screen shown in (a) of FIG. 4 may be displayed in response to an interaction with the menu interface 321 for inputting an emoticon in the profile background in (b) of FIG. 3. As an interaction with the menu interface 321 in FIG. 3 is input, a menu interface 411 may be displayed in an activated form in FIG. 4.

The user terminal 10 may display the first input interface 420 for posting an emoticon on the background of a profile page 410. The first input interface 420 may be displayed to overlap a portion of the user's profile page 410.

The first input interface 420 may include a tab area 430 and a selection area 440. A plurality of tabs may be displayed in the tab area 430. Specifically, a Favorites/Recently Used tab 431, emoticon function-related tabs 432, and Custom Set tabs 433 may be displayed in the tab area 430. In the tab area 430, the Favorites/Recently Used tab 431 and the Custom Set tabs 433 may correspond to user custom information that reflects the user's emoticon historical information.

Here, the Custom Set tabs 433 may be tabs corresponding to emoticon sets designated by the user through purchasing, downloading, possessing, receiving as a gift, or the like. The Custom Set tabs 433 may be displayed as icon images of the corresponding emoticon sets. The Custom Set tabs 433 may be displayed as the icon images in the order specified by the user for the corresponding emoticon sets.

In (a) of FIG. 4, there is illustrated a screen where the Favorites/Recently Used tab 431 is selected in the tab area 430 and thumbnails of emoticons specified as favorites are displayed in the selection area 440.

In (b) of FIG. 4, there is illustrated a screen of the user terminal 10 having performed operations 207 and 209 of FIG. 2.

Specifically, (b) of FIG. 4 illustrates the result of selecting a tab 434 in the tab area 430. As the tab 434 is selected, emoticon thumbnails of an emoticon set corresponding to the tab 434 may be displayed in the selection area 440.

The screen shown in (b) of FIG. 4 corresponds to a case where a selection interaction of selecting the thumbnail of a first emoticon 441 is input in the selection area 440. When obtaining the selection interaction of selecting the first emoticon 441, the user terminal 10 may display, in the profile background, an editing interface for modifying or changing the display format of a first emoticon 450.

The editing interface may include a position setting interface 451, a resize interface 452, a rotation setting interface 453, and a delete setting interface 454 for the first emoticon 450. In addition, although not shown in the drawings, the user may also be able to set the transparency or color of the editing interface.

Although not shown in (b) of FIG. 4, in some cases, the first emoticon may be an emoticon that is recommended to be organically associated with the profile image on the profile page. For example, the first emoticon is an image of glasses, and the first emoticon may be recommended to be posted in such a way that the glasses are appropriately worn on the face of a person or character shown in the profile image. In this case, the editing interface may provide suggested location information for the first emoticon based on characteristics of the profile image.

When the user inputs an interaction with a complete interface 461, the user terminal 10 may request the server 30 to post the first emoticon on the background area of the user's profile page.

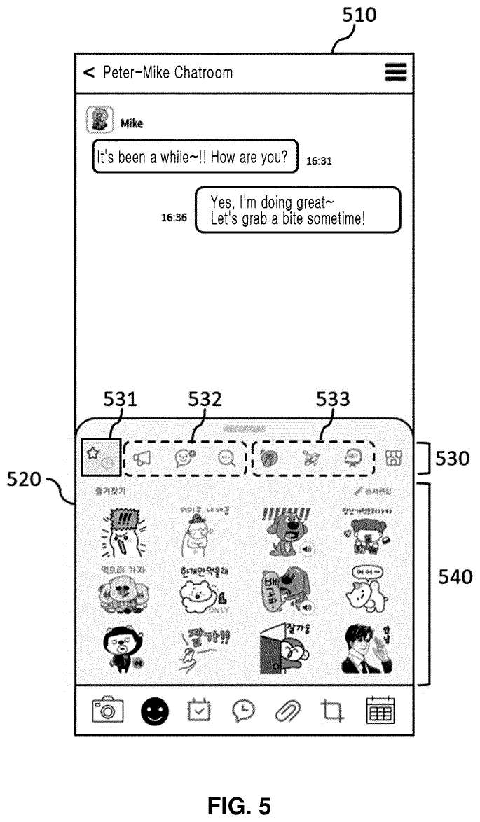

FIG. 5 illustrates a screen where a second input interface 510 for the user terminal 10 to input an emoticon in a chat room is displayed.

Referring to FIG. 5, the user terminal 10 may display a second input interface 520 for inputting an emoticon to be displayed in a chat message in a chat room 510.

The second input interface 520 may be identical or similar to the first input interface 420. Specifically, the second input interface 520 may include a tab area 530 and a selection area 540. A plurality of tabs may be displayed in the tab area 530.

Specifically, the tab area 530 may display a Favorites/Recently Used tab 531, emoticon function-related tabs 532, and Custom Set tabs 533. In the tab areas 530, the Favorites/Recently Used tab 531 and the Custom Set tabs 533 may correspond to user custom information that reflects the user's emoticon historical information.

The Favorites/Recently Used tab 531 and Custom Set tabs 533 corresponding to user custom information in the second input interface 520 may be displayed in the same manner as the Favorites/Recently Used tab 431 and the Custom Set tabs 433 corresponding to the user customization information in the first input interface 420. Specifically, the first and second input interfaces 420 and 520 may display the same type, image, or order of tabs corresponding to the user-customized information.

As shown in FIGS. 4 and 5, an input interface for inputting an emoticon on a user's profile page and an input interface for inputting an emoticon in a chat message are identical or similar to each other, and thus, there is an advantage that a user can conveniently input an emoticon using a familiar interface.

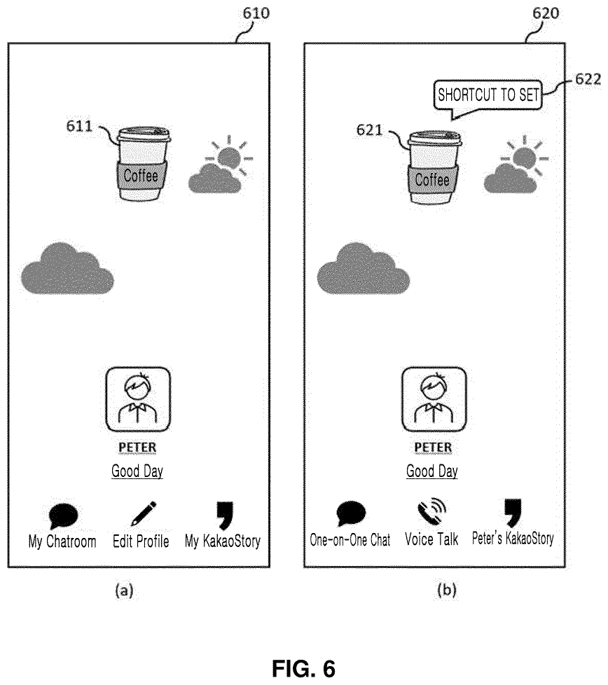

FIG. 6 illustrates a screen of the user terminal 10 and the other user terminal 20 having performed operation 211 of FIG. 2. Specifically, FIG. 6 corresponds to a screen where an emoticon is posted on the background of the profile page.

A screen shown in (a) of FIG. 6 may be displayed when an interaction with the complete interface 461 is obtained from the user in the screen shown in (b) of FIG. 4.

Referring to (a) of FIG. 6, the user terminal 10 may display a first emoticon 611 on the profile background of the user's profile page 610. The first emoticon 611 may be displayed according to display options set by the user in (b) of FIG. 4.

In (b) of FIG. 6, there is illustrated a screen where the other user terminal 20 is viewing the user's profile page 620 on which a first emoticon 621 is displayed.

The screen shown in (b) of FIG. 6 may be displayed on the other user terminal 20 in response to the other user terminal 20 requesting the server 30 to view the user's profile page 620.

In some cases, the other user terminal 20 may display a shortcut interface 622 of an emoticon set including the first emoticon 621. The shortcut interface 622 may be displayed by default on the user's profile page 620 or may be displayed in response to a separate interaction (e.g., a long tap) from the other user. The shortcut interface 622 may be a landing interface that connects to a page for an emoticon set including a first emoticon 601.

FIG. 7 illustrates a screen of the user terminal 10 having performed operations 205, 207, and 209 of FIG. 2. Specifically, FIG. 7 corresponds to a screen for posting an emoticon on a profile image.

Referring to FIG. 7, the user terminal 10 may display a first input interface 720. The screen in FIG. 7 may be displayed in response to the user's interaction with the profile image interface 322 shown in (b) of FIG. 3.

The user terminal 10 may display a first input interface 720 for posting an emoticon on a profile image. The first input interface 720 may include a tab area 730 and a selection area 740. A plurality of tabs may be displayed in the tab area 730. At least a portion of the tab area 730 may correspond to user custom information that reflects the user's emoticon historical information.

The details of the first input interface 720 may be identical to those of the first input interface 420 of FIG. 4. A detailed description of the first input interface 720 will overlap with the description of FIG. 4.

When obtaining a selection interaction of selecting a thumbnail 741 of a first emoticon via the first input interface 720, the user terminal 10 may display the first emoticon 752 at a predetermined position within a template 750 of the profile image. In addition, the user terminal 10 may obtain text information 751 from the user and display the text information 751 at a predetermined position within the template 750 of the profile image.

When obtaining input information regarding both the first emoticon 741 and the text information 751, the user terminal 10 may display a profile image including both the first emoticon 741 and the text information 751.

In some cases, the profile image template 750 may be configured not to display a portion of the text information 751 or the first emoticon 752. Specifically, when obtaining an interaction with an emoticon deletion interface 753 from the user, the user terminal 10 may display only the text information 751 in the profile image template 750, without the first emoticon 752.

In addition, although not shown in the drawing, the user may also be able to set the transparency or color of the profile image.

When the user inputs an interaction with a complete interface 761, the user terminal 10 may request the server 30 to post the first emoticon and the text information in the profile image area of the user's profile page.

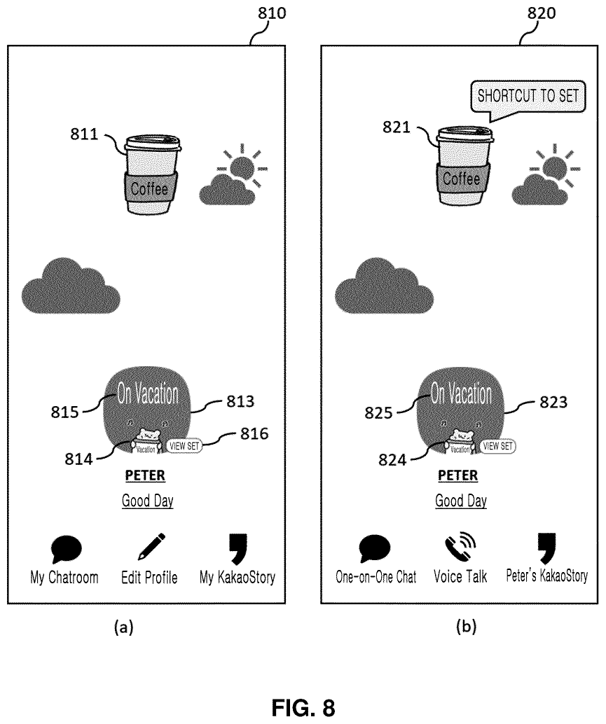

FIG. 8 illustrates a screen of the user terminal 10 and the other user terminal 20 having performed operation 211 of FIG. 2. Specifically, FIG. 8 corresponds to a screen where an emoticon is posted on a profile image of a profile page.

A screen shown in (a) of FIG. 8 may be displayed when an interaction with the complete interface 761 is obtained from the user in FIG. 7.

Referring to (a) of FIG. 8, the user terminal 10 may display a first emoticon 814 and text information 815 on a profile image 813 of the user's profile page 810. The profile image 810 including the first emoticon 814 and the text information 815 may be displayed according to display options set by the user in FIG. 6.

In addition, the user terminal 10 may display an emoticon 811 on the profile background of the user's profile page 810. The emoticon 811 may be displayed according to display options set by the user in (b) of FIG. 4.

In some cases, unlike the screen shown in FIG. 6, the user terminal 10 may display a shortcut interface 816 for an emoticon set including the first emoticon 814.

A screen shown in (b) of FIG. 8 may be displayed on the other user terminal 20 in response to the other user terminal 20 requesting the server 30 to view the user's profile page 820.

Referring to (b) of FIG. 8, the other user terminal 20 may display a profile image 823 of the user's profile page 820. The profile image 823 containing the first emoticon 824 and the text information 825 may be displayed according to display options set by the user in FIG. 6.

In addition, the other user terminal 20 may display an emoticon 821 on the profile background of the user's profile page 820. The emoticon 821 may be displayed according to display options set by the user in (b) of FIG. 4.

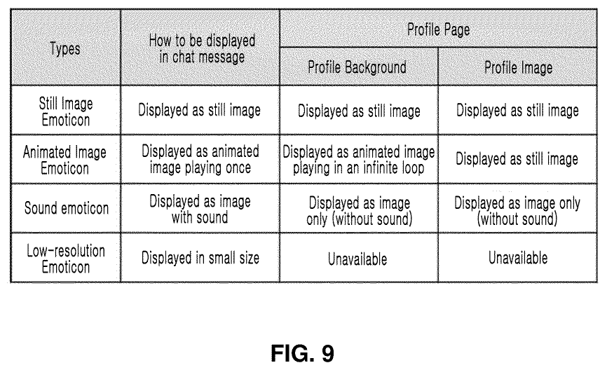

In the following description, reference will be made to FIG. 9 to describe the specific forms of emoticons to be displayed on a profile page (see FIGS. 6 and 8), which vary depending on the types of emoticons.

FIG. 9 illustrates a table for explaining the types of emoticons displayed in a profile background or profile image on a profile page of the user terminal 10.

Emoticons may be categorized into still image emoticons, animated image emoticons, sound emoticons, and low-resolution emoticons, based on how the emoticons are displayed in chat messages.

An emoticon classified as a still image emoticon type may be displayed as a still image when the emoticon is displayed in any of a chat message, a profile background, and a profile image.

In addition, an emoticon classified as an animated image emoticon type may be displayed in a manner where an animated image thereof is played once when the emoticon is included and displayed in the chat message. When the emoticon is included and displayed in the profile background, the emoticon may be displayed in a manner where an animated image thereof is played in an infinite loop. When the emoticon is included and displayed in the profile image, the emoticon may be displayed as a still image included in an animated image.

In addition, an emoticon corresponding to the sound emoticon type may be displayed or output in a manner where the image is displayed and sound thereof is played simultaneously when the emoticon is included and displayed in the chat message. However, when the sound emoticon is included and displayed on the profile page, only the image thereof may be displayed without sound.

In addition, an alert may be provided for a low-resolution emoticons to indicate unavailability, which is caused by difficulties in displaying the emoticon clearly on the profile page due to resolution issues.

The types of emoticons are not limited to the examples described above. Also, the ways in which each type of emoticon is displayed on the profile page are not limited to the examples described above. The ways in which each type of emoticon is displayed on the profile page may be changed in various ways.

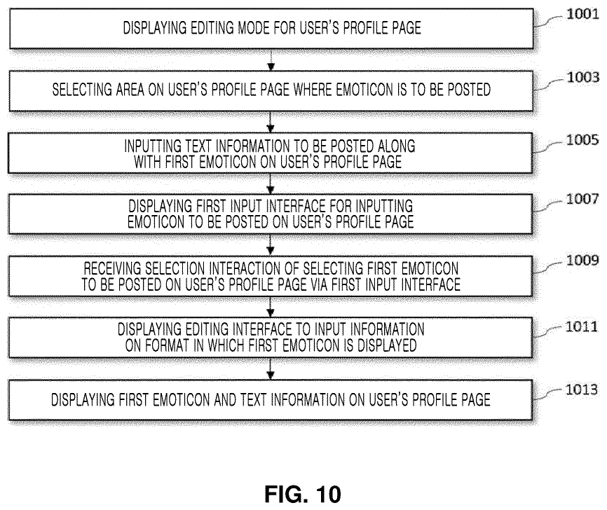

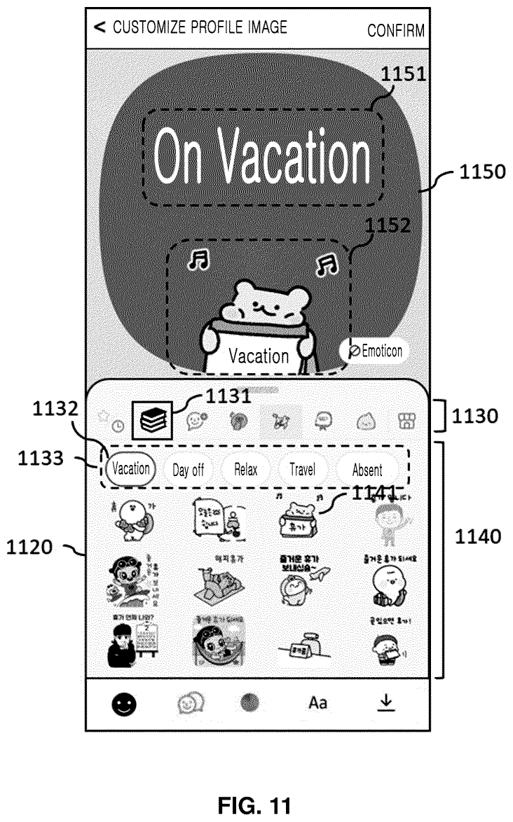

Hereinafter, another embodiment of a method for providing an emoticon input interface by the user terminal 10 of the present disclosure will be described with reference to FIGS. 10 and 11.

FIG. 10 is a flowchart for explaining a method for providing an emoticon input interface by the user terminal 10 of the present disclosure.

For the sake of convenience in explanation, the description of operations substantially identical to those of FIG. 2 among the operations in FIG. 10 will reference the corresponding description of FIG. 2. Specifically, operations 1001, 1003, 1009, 1011, and 1013 of FIG. 10 are substantially identical to operations 201, 203, 207, 209, and 211 of FIG. 2, respectively.

In operation 1005, the user terminal 10 receives text information to be posted along with a first emoticon on a user's profile page.

The text information may be a status message displayed on the user's profile page or a text message included in a profile image. In this embodiment, the user terminal 10 receives the text information before information about the first emoticon.

In operation 1007, a first input interface for inputting an emoticon to be posted on the user's profile page is displayed. Here, the first input interface is displayed with recommended emoticons based on the text information. The recommended emoticons may be selected based on keyword information matched to the emoticons.

Accordingly, there is an advantage in that a user is able to conveniently select an emoticon corresponding to text information the user wishes to post on a profile page.

FIG. 11 exemplarily illustrates a screen in the process of performing a method for providing an emoticon input interface by the user terminal 10 according to embodiments of the present disclosure.

FIG. 11 illustrates a screen of the user terminal 10 having performed operations 1005, 1007, and 1009 of FIG. 10. Specifically, FIG. 11 corresponds to a screen for posting an emoticon on a profile image.

Referring to FIG. 11, the user terminal 10 may display a first input interface 1120 for posting an emoticon on a profile image. The first input interface 1120 may include a tab area 1130 and a selection area 1140. A plurality of tabs may be displayed in the tab area 1130. The tab area 1130 may include a keyword information-based tab 1131.

Details of the first input interface 1120 may be identical to those of the first input interface 420 of FIG. 4. A detailed description of the first input interface 1120 will overlap with the description of FIG. 4.

Referring to FIG. 11, the user terminal 10 may display text information 1151 input in operation 1005 of FIG. 10. Also, at least one keyword 1133 selected based on the text information 1151 may be displayed. When a user selects one keyword 1132 among the at least one keyword 1133, a thumbnail of an emoticon corresponding to the selected keyword 1132 is displayed in the selection area 1140.

When obtaining a selection interaction of selecting a thumbnail 1141 of the first emoticon via the first input interface 1120, the user terminal 10 may display a first emoticon 1152 at a predetermined position within a template 1150 of the profile image.

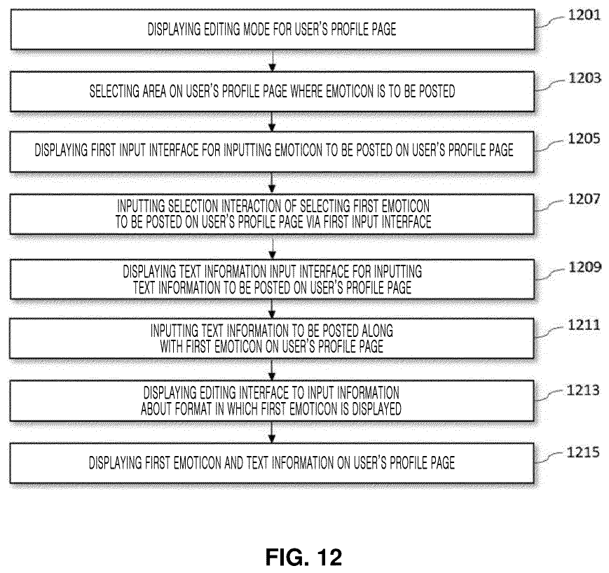

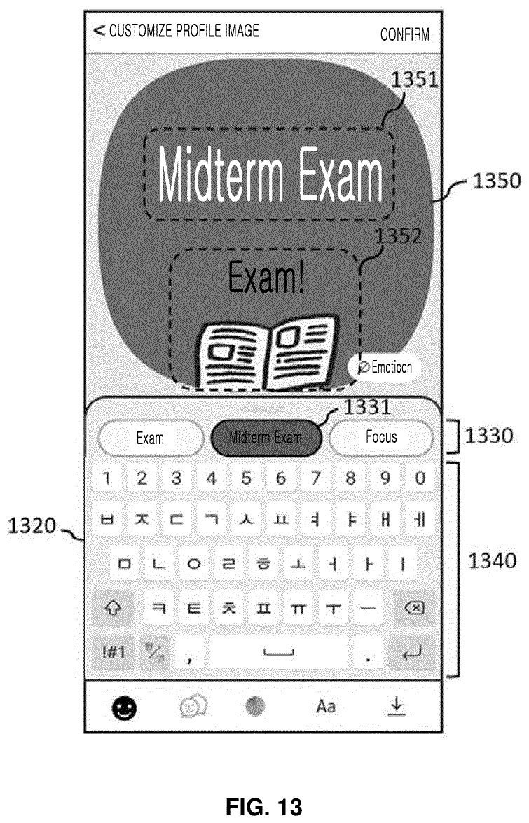

Hereinafter, yet another embodiment of a method for providing an emoticon input interface by the user terminal 10 of the present disclosure will be described with reference to FIGS. 12 and 13.

FIG. 12 is a flowchart for explaining a method for providing an emoticon input interface by the user terminal 10 of the present disclosure.

For the sake of convenience in explanation, the description of operations substantially identical to those of FIG. 2 among the operations in FIG. 12 will reference the corresponding description in FIG. 2. Specifically, operations 1201,1203, 1205, 1207, 1213, and 1215 of FIG. 12 are substantially identical to operations 201, 203, 205, 207, 209, and 211 of FIG. 2, respectively.

In operation 1207, the user terminal 10 receives a selection interaction of selecting a first emoticon to be posted along with text information on the user's profile page.

Then, in operation 1209, a text information input interface for inputting text information to be posted on the user's profile page is displayed.

Here, the text information input interface may be a keyword interface for inputting a text. The text information input interface may show recommended text information based on the first emoticon. The recommended text information may be selected based on keyword information matched to the first emoticon.

Thereafter, in operation 1211, the text information to be posted along with the first emoticon on the user's profile page is input. This method offers the advantage of enabling a user to conveniently select text information corresponding to an emoticon that the user wishes to post on the profile page.

FIG. 13 exemplarily illustrates a screen in the process of performing a method for providing an emoticon input interface by the user terminal 10 according to embodiments of the present disclosure.

FIG. 13 illustrates a screen of the user terminal 10 having performed operations 1207, 1209, and 1211 of FIG. 12. Specifically, FIG. 13 corresponds to a screen for posting an emoticon on a profile image.

Referring to FIG. 13, the user terminal 10 may display a first emoticon 1352 input in operation 1207 of FIG. 12.

Referring to FIG. 13, the user terminal 10 may display a text input interface 1320 for posting text information on a profile image. The text input interface 1320 may include a keyword area 1330 and a keyboard area 1340. In the keyword area 1330, a plurality of keyword interfaces associated with keywords of the first emoticon 1352 selected may be displayed. In FIG. 13, the user has selected the “midterm exam” keyword interface.

When obtaining a selection interaction of selecting a selected keyword 1331 through the text input interface 1320, the user terminal 10 may display a selected keyword 1351 at a predetermined position within a template 1350 of a profile image.

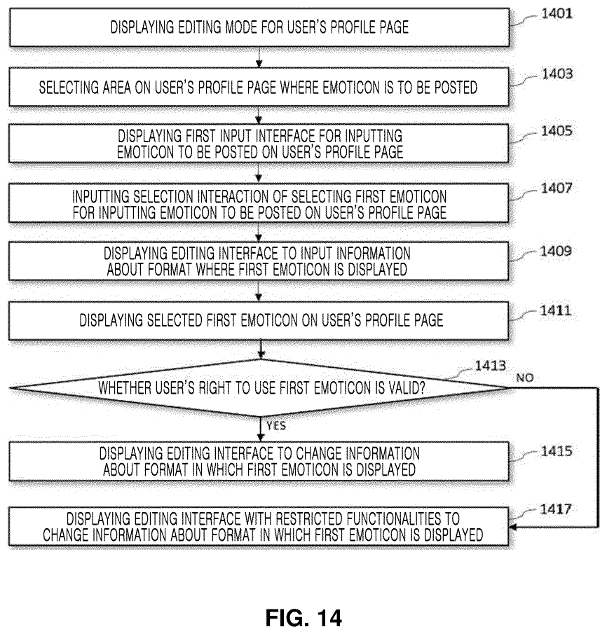

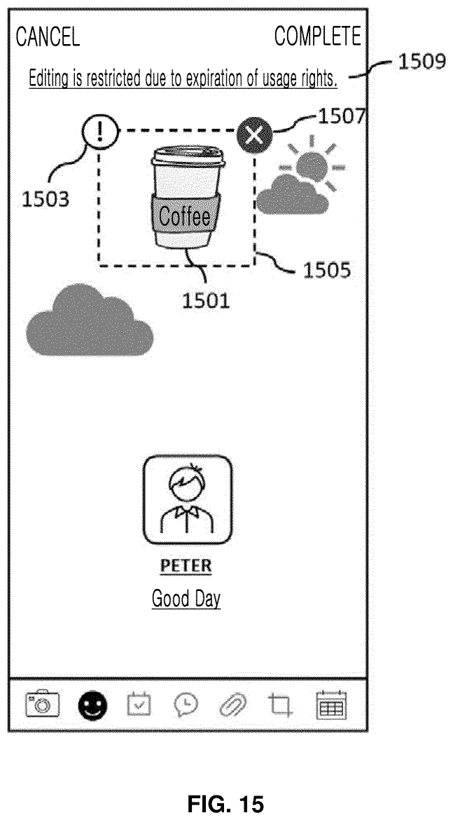

Hereinafter, yet another embodiment of a method for providing an emoticon input interface by the user terminal 10 of the present disclosure will be described with reference to FIGS. 14 and 15.

FIG. 14 is a flowchart for explaining a method for providing an emoticon input interface by the user terminal 10 of the present disclosure.

For the sake of convenience in explanation, the description of operations substantially identical to those of FIG. 2 among the operations in FIG. 14 will reference the corresponding description of FIG. 2. Specifically, operations 1401 to 1411 of FIG. 14 are substantially identical to operations 201 to 211 of FIG. 2, respectively.

In operation 1413, the user terminal 10 determines whether the user's right to use the first emoticon is valid.

If the user's right to use the first emoticon is valid, operation 1415 is performed. In operation 1415, the user terminal 10 displays an editing interface for changing information about the display format of the first emoticon in response to the user's request to edit the first emoticon. The editing interface in operation 1415 may provide a function to adjust the position, size, or rotation of the first emoticon.

However, if the user's right to use the first emoticon is not valid, operation 1417 is performed. In operation 1417, the user terminal 10 displays an editing interface with restricted functionalities to change information about a display format of the emoticon, in response to an editing request for the user's first emoticon.

Specifically, the editing interface in operation 1417 may have a restricted range of editing functions compared to the editing interface in operation 1415. For example, the editing interface in operation 1417 may provide a function to adjust only the position where the first emoticon is displayed, with the function to adjust the size or rotation of the first emoticon being restricted and not provided.

FIG. 15 exemplarily illustrates a screen in the process of performing a method for providing an emoticon input interface by the user terminal 10 according to embodiments of the present disclosure.

FIG. 15 illustrates a screen of the user terminal 10 having performed operation 1417 of FIG. 14.

Referring to FIG. 15, the user terminal 10 may display an editing interface with restricted functionalities to change information about a display format of a first emoticon 1501.

Specifically, the editing interface with restricted functionalities may include only a position setting interface 1505 and a deletion setting interface 1507 for the first emoticon 1501. Unlike the case where the user's right to use the first emoticon is valid, a resize interface and a rotation setting interface may not be provided. Instead, information 1503 and 1509 indicating that editing is restricted due to the expiration of the right to use the first emoticon may be displayed.

In some cases, unlike what is shown in FIG. 15, if the user's right to use the first emoticon expires, functionalities associated with posting the first emoticon on the profile page may be restricted differently. For instance, the position setting function, in addition to the resizing and rotation functions, may also be restricted, resulting in the absence of the position adjustment interface 1505 shown in FIG. 15.

In some cases, when the user's right to use the first emoticon expires, unlike what is shown in FIG. 15, information about the expiration of usage rights may be displayed in a different way. For example, the first emoticon displayed on the profile page may be altered to have lower resolution or displayed in black and white.

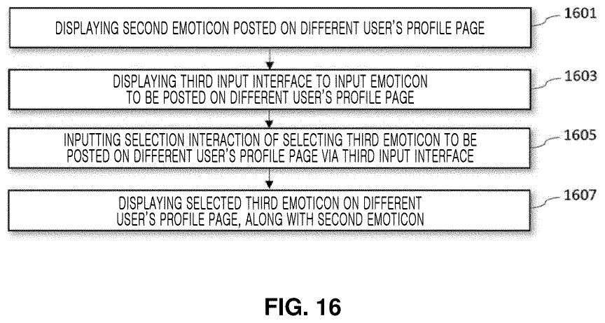

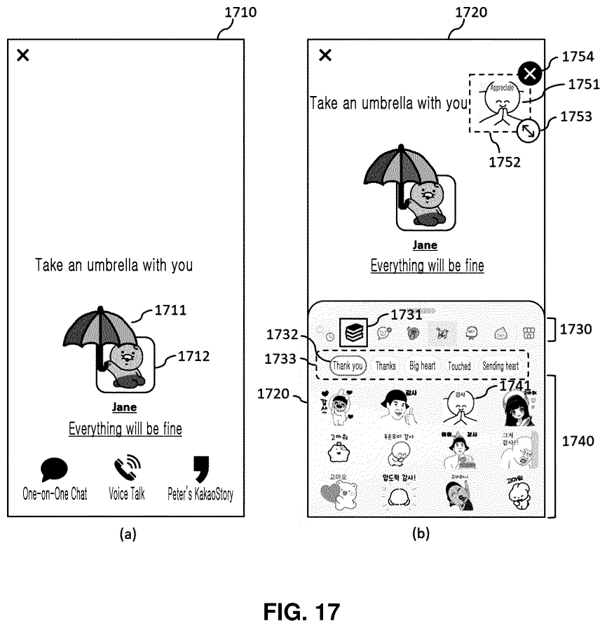

Hereinafter, yet another embodiment of a method for providing an emoticon input interface by a user terminal 10 of the present disclosure will be described with reference to FIGS. 16 and 17.

FIG. 16 is a flowchart for explaining a method for providing an emoticon input interface by the user terminal 10 of the present disclosure.

In operation 1601, the user terminal 10 displays a second emoticon posted on the other user's profile page. Here, the server 30 may provide the user terminal 10 with a function of posting a third emoticon on the other user's profile page. Here, the third emoticon posted by the user terminal 10 may be a reply to the second emoticon.

In operation 1603, the user terminal 10 displays a third input interface for inputting an emoticon to be posted on the other user's profile page.

The third input interface may be identical or similar to the first input interface described above. The third input interface may also include user custom information that is at least partially identical to that of the second input interface. Here, the third input interface may include recommended emoticons based on the second emoticon.

The recommended emoticons based on the second emoticon may be determined in various ways. As an example, the recommended emoticons may be emoticons with the same characteristic information (e.g., creator, base character, and emotional keyword) as that of the second emoticon. For example, if the second emoticon is an emoticon created by creator A, emoticons created by the same creator A may be determined as the recommended emoticons. As another example, the recommended emoticons may be emoticons having a keyword corresponding to the second emoticon. For example, if the second emoticon is an emoticon with the keyword “birthday”, the recommended emoticons may be determined to be emoticons with the keyword “congratulations”, which is a keyword corresponding to “birthday”.

In operation 1605, the user terminal 10 receives a selection interaction of selecting a third emoticon to be posted on the other user's profile page via a third input interface.

In operation 1607, the user terminal 10 displays the third emoticon posted on the other user's profile page, along with the second emoticon.

In the embodiment described with reference to FIG. 16, the user terminal 10 requests posting of the third emoticon on the other user's profile page. However, on the contrary, it is also possible for the other user terminal 20 to request posting of a fourth emoticon as a reply to the first emoticon posted on the user's profile page.

FIG. 17 exemplarily illustrates a screen in the process of performing a method for providing an emoticon input interface by the user terminal 10 according to embodiments of the present disclosure.

In (a) of FIG. 17, there is illustrated a screen of the user terminal 10 having performed operation 1601 of FIG. 16.

Referring to (a) of FIG. 17, the user terminal 10 may display a second emoticon 1711 posted on the other user's profile page 1710. Here, the second emoticon 1711 may be displayed in association with a profile image 1712. In (a) of FIG. 17, the second emoticon 1711 including an umbrella image may be recommended to be displayed with the handle of an umbrella overlapping the hand of a character included in the profile image 1712, depicting the character as holding the umbrella. Referring to (a) of FIG. 17, the umbrella of the second emoticon 1711 is depicted as being held in the hand of the character included in the profile image 1712.

Before operation 1601 of FIG. 16 is performed, if the other user selects the second emoticon 1711 to be posted on his or her own profile page, recommendation information may be provided in an editing interface suggesting that the second emoticon 1711 be positioned to overlap with the hand of the character included in the profile image 1711.

In (b) of FIG. 17, there is illustrated a screen of the user terminal 10 having performed operations 1603, 1605, and 1607 of FIG. 16.

Referring to (b) of FIG. 17, the user terminal 10 may display a third input interface 1720 for inputting an emoticon to be posted on the other user's profile page 1720. The third input interface 1720 may include a tab area 1730 and a selection area 1740. A plurality of tabs may be displayed in the tab area 1730. The tab area 1730 may include a tab 1731 based on keyword information.

Details of the third input interface 1720 may be identical to those of the first input interface 1120 of FIG. 11. A detailed description of the first input interface 1720 will reference the description of FIG. 11.

Referring to FIG. 17, the user terminal 10 may display at least one keyword 1733 associated with the second emoticon posted on the other user's profile page. When the user selects a keyword 1732 among the at least one keyword 1733, a thumbnail of an emoticon associated with the selected keyword 1733 is displayed in the selection area 1740.

For example, referring to FIG. 17, the user terminal 10 or the server 30 may identify the keyword “kindness” associated with the second emoticon 1711 and find response keywords 1733 such as “thank you” or “thanks” corresponding to the keyword “kindness.” The user terminal 10 may display each found keyword in a tab form.

When obtaining a selection interaction of selecting a thumbnail 1741 of a third emoticon via the third input interface 1720, the user terminal 10 may display a third emoticon 1751 and editing interfaces 1752, 1753, and 1754 on the other user's profile page 1720.

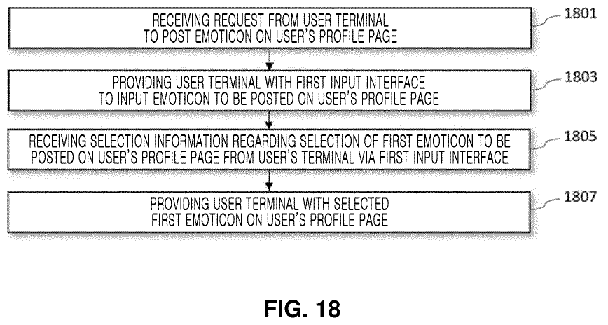

Hereinafter, a method for providing an emoticon input interface by the server 30 of the present disclosure will be described with reference to FIG. 18.

The above-described method for providing an emoticon input interface, as referenced in FIGS. 2 to 17, is to be performed by the user terminal 10. However, in some cases, the server 30 may be connected to the user terminal 10 over a network to provide the user terminal 10 with pertinent information so that the user terminal 10 can provide an emoticon input interface.

The method for the server 30 to provide an emoticon input interface, as described with reference to FIG. 18, is substantially similar to the method for the user terminal 10 to provide an emoticon input interface, as described with reference to FIGS. 2 to 17. Therefore, for the sake of convenience in explanation, some of the same content as described above with reference to FIGS. 2 to 17 will reference the above-described content.

FIG. 18 is a flowchart for explaining a method for providing an emoticon input interface by the server 30 of the present disclosure.

In operation 1801, the server 30 receives a request from the user terminal 10 to post an emoticon on a user's profile page. Operation 1803 corresponds to operation 201 in FIG. 2. An example screen of the user terminal 10 when operation 1801 is performed is shown in FIG. 3.

In operation 1803, the server 30 provides the user terminal 10 with a first input interface for inputting an emoticon to be posted on the user's profile page. Operation 1803 corresponds to operation 205 in FIG. 2. Example screens of the user terminal 10 when operation 1803 is performed are shown in (a) of FIG. 4 and FIG. 7.

In operation 1805, the server 30 receives selection information regarding selection of a first emoticon to be posted on the user's profile page from the user terminal 10 via the first input interface. Operation 1805 corresponds to operation 207 in FIG. 2. Example screens of the user terminal 10 when operation 1805 is performed are shown in (b) of FIG. 4 and FIG. 7.

In operation 1807, the server 30 provides the user terminal 10 with the first emoticon posted on the user's profile page. Operation 1807 corresponds to operation 211 in FIG. 2. Example screens of the user terminal 10 when operation 1807 is performed are shown in FIGS. 6 and 8.

According to the present disclosure, it is possible to provide a method for providing an emoticon input interface for easily inputting an emoticon to post on a user's profile page in a messaging service.

In addition, according to the present disclosure, it is possible to reflect the user's emoticon historical information in the emoticon input interface provided for posting emoticons on the user's profile page in the messenger service.

The technical features disclosed in each embodiment of the present disclosure are not limited only to a corresponding embodiment, but the technical features in the respective embodiments may be combined and applied to different embodiments unless they are mutually incompatible.

Therefore, although each embodiment has been described mainly about a technical feature thereof, the technical features may be combined unless they are mutually incompatible.

The present disclosure is not limited to the above-described embodiment and the accompanying drawings, and various modifications and changes may be made in view of the person skilled in the art to which the present disclosure pertains. Therefore, the scope of the present disclosure should be determined by equivalents to the claims, as well as by the claims of the present disclosure.

What is claimed is:

1. A method for providing an emoticon input interface by a user terminal, the method comprising:
displaying a first input interface for inputting an emoticon to be posted on a profile page of a user;
receiving a selection interaction of selecting a first emoticon to be posted on the profile page of the user via the first input interface; and
displaying the selected first emoticon on the profile page of the user,
wherein the first input interface comprises user custom information associated with emoticon historical information of the user, and
wherein the user custom information is identical to at least a part of user custom information for a second input interface for inputting an emoticon to be displayed in a chat message.

2. The method of claim 1, wherein the historical information is associated with at least one of the user's recent usage history, favorite history, purchase history, download history, and possession history regarding emoticons.

3. The method of claim 1,
wherein each of the first and second input interfaces comprises:
a tab area having at least one tab associated with the historical information; and
a selection area for displaying an emoticon thumbnail to be selected by a selection interaction, and
wherein the user custom information is displayed in the tab area.

4. The method of claim 3, wherein in both the first and second input interfaces, tabs in the tab area are provided with same configuration and order.

5. The method of claim 1,
wherein the profile page of the user comprises a profile background and a profile image, and
wherein the first emoticon is displayed and posted on at least one of the profile background and the profile image.

6. The method of claim 5, further comprising:
in response to the first emoticon being displayed and included in the profile background, displaying an editing interface for inputting information about a format in which the first emoticon is displayed in the profile background, wherein displaying the editing interface is performed between receiving the selection interaction and displaying the profile page.

7. The method of claim 5, wherein in response to the first emoticon being displayed and included in the profile background, the first emoticon is displayed in association with the profile image.

8. The method of claim 1, further comprising:
receiving text information to be posted along with the first emoticon on the profile page of the user,
wherein in displaying the first emoticon, the text information input to the profile page of the user is displayed along with the first emoticon, and
wherein in response to receiving the text information being performed before receiving the selection interaction, the first input interface comprises information about at least one recommended emoticon associated with the text information in displaying the first input interface.

9. The method of claim 1, further comprising:
receiving text information to be posted along with the first emoticon on the profile page of the user,
wherein in displaying the first emoticon, the text information input to the profile page of the user is displayed along with the first emoticon, and
wherein in response to receiving the selection interaction being performed before receiving the text information, the text input interface for inputting the text information comprises at least one recommended text information associated with the first emoticon in receiving the text information.

10. The method of claim 1, wherein in displaying the profile page, the first emoticon is displayed in a modified manner different from a manner in which the first emoticon is displayed in the chat message.

11. The method of claim 10, wherein the manner in which the first emoticon is displayed in the chat message comprises an animated image, the modified manner is at least one of the following: a manner in which the animated image is played repeatedly or a manner in which a still image associated with a still image is displayed.

12. The method of claim 1, further comprising: after displaying the first emoticon, displaying an editing interface to change information about a format in which the first emoticon is displayed on the profile page,
wherein in displaying the editing interface, in response to the user's right to use the first emoticon expires, an editing interface with restricted functionalities is displayed, compared to when the right to use the emoticon is valid.

13. The method of claim 1, wherein displaying the first emoticon comprises providing an interface that connects to an emoticon set comprising the first emoticon.

14. The method of claim 1, further comprising:
displaying a second emoticon posted on a profile page of a different user;
displaying a third input interface for inputting an emoticon to be posted on the profile page of the different user;
receiving a selection interaction of selecting a third emoticon to be posted on the profile page of the different user via the third input interface; and
displaying the selected third emoticon on the profile page of the different user along with the second emoticon,
wherein the third input interface is identical to at least a part of custom information for the first input interface.

15. The method of claim 14, wherein in displaying the third input interface, the third input interface comprises information about at least one recommended emoticon associated with the second emoticon.

16. The method of claim 1, further comprising, after displaying the first emoticon, displaying, along with the first emoticon, a fourth emoticon posted on the profile page of the user, wherein the fourth emoticon is an emoticon requested by the different user to be posted on the user's profile page in association with the first emoticon.

17. A method for providing an emoticon input interface by a server, the method comprising:
receiving a request from a user terminal to post an emoticon on a profile page of a user;
providing the user terminal with a first input interface for inputting an emoticon to be posted on the profile page of the user;
receiving selection information regarding selection of a first emoticon to be posted on the profile page of the user from the user terminal via the first input interface; and
providing the user terminal with the selected first emoticon on the user's profile page,
wherein the first input interface comprises user custom information associated with emoticon historical information of the user, and
wherein the user custom information is identical to at least a part of user custom information for a second input interface for inputting an emoticon to be displayed in a chat message.

18. The method of claim 17, further comprising:
after providing the first emoticon, providing an editing interface to change information about a format in which the first emoticon is to be displayed on the profile page,
wherein in providing the editing interface, in response to the user's right to use the first emoticon expired, an editing interface with restricted functionality is provided compared to when the right to use the first emoticon is valid.

19. A server for providing an emoticon input interface, the server comprising:
a memory storing instructions, and
a processor connected to the memory and configured to execute the instructions to:
receive a request from a user terminal to post an emoticon on a profile page of a user;
provide the user terminal with a first input interface for inputting an emoticon to be posted on the profile page of the user;
receive selection information regarding selection of a first emoticon to be posted on the profile page of the user from the user terminal via the first input interface; and
provide the user terminal with the selected first emoticon on the user's profile page,
wherein the first input interface comprises user custom information associated with emoticon historical information of the user, and
wherein the user custom information is identical to at least a part of user custom information for a second input interface for inputting an emoticon to be displayed in a chat message.
